(19) United States
(12) Patent Application Publication
(10) Pub. No.: US 2021/0039319 A1
(43) Pub. Date: Feb. 11, 2021

(54) METHOD FOR ADDITIVE MANUFACTURE OF A THREE-DIMENSIONAL OBJECT

(71) Applicant: RUHR-UNIVERSITÄT BOCHUM, Bochum (DE)

(72) Inventors: Michael RIEGER, Hassloch (DE); BENJAMIN JOHNEN, Dortmund (DE); BERND KUHLENKÖTTER, Rinkerode (DE)

(73) Assignee: RUHR-UNIVERSITÄT BOCHUM, Bochum (DE)

(21) Appl. No.: 16/491,851

(22) PCT Filed: Feb. 13, 2018
(86) PCT No.: PCT/DE2018/100123

§ 371 Date: Sep. 6, 2019

(30) Foreign Application Priority Data
Mar. 7, 2017 (DE) 10 2017 104 738.7

(51) Int. Cl. B29C 64/386; B29C 64/118; B33Y 50/00

(52) U.S. Cl. CPC B29C 64/386; B33Y 50/00; B29C 64/118

(57) ABSTRACT

Beginning on a starting area on a surface of a digital model, a layered subdivision of the model takes place to produce a three-dimensional object. Positioning of the layers on the starting area is based on calculation of a distance field, which assigns to each point of the model volume a shortest distance within the volume to the nearest starting area. For each discrete point of a layer defined by a distance field an orientation of a processing head is determined. The surface normal of the layer is calculated or gradient vectors of the distance field are calculated, which show a direction of the steepest rise in distances for the discrete point. Shape and distribution of layers conform to the shape of the digital model. The sequence for the adaptive construction results from the assignment of the layers to distance values, beginning with a lowest distance value in ascending order.

The invention relates to a method for additive manufacture of a three-dimensional object according to the features of patent claim 1.

Today's additive manufacturing processes normally build up the geometries to be produced in horizontal, planar and parallel layers. The type of layered model design of systems available on the market is related to the kinematic constraint of movement kinematics that guide in the additive process head which implements the construction of the object element by element or layer by layer. In the case of the additive manufacturing process fused layer manufacturing, part of the process head is used to dispense via a nozzle a starting material which has been transferred to a liquid or pasty state. The starting material solidifies after extrusion from the nozzle. The movement kinematics are usually equipped with three linear movement axes, so-called linear portal kinematics, to prevent a possibility of orientation of the process head in the process. With these three degrees of freedom, it is only possible to position the process head in the three spatial directions during the course of the process, but not to orientate it. In this case, only two of the three movement axes, which span a horizontal plane, are designed for a synchronous, continuous path control. In addition, geometrical slicing processes and path planning processes are suited to these kinematics for planning the trajectory of the process head and for controlling the movement axes. Known geometrical slicing strategies focus on the realization of the described simple layer slicing or layer build-up pattern, in which in the context of an additive manufacturing process, guidance of the process head with a linear portal kinematics can easily be planned and implemented.

At transitions, for example as a result of holes or protrusions, known geometrical slicing strategies reach their limits when no support structures are to be used.

The invention is based on the object to provide a method for additive manufacture of a three-dimensional object by means of individual, freely formed layers, the structure and arrangement of which allowing modeling of the component without support structures.

This object is attained by a method having the features of patent claim 1.

Advantageous refinements of the invention are subject matter of the subclaims.

The method according to the invention for additive manufacture of a three-dimensional object initially provides initially the provision of a digital model of the component to be modeled. The digital model can be both a discretized voxel model and a parametric model, which can be discretized locally if necessary. At least one starting surface or several starting surfaces are defined on a surface of the digital model. A starting surface is the starting point on which a layered subdivision of the model begins. The layers are built up successively to the three-dimensional object.

The method according to the invention is characterized in that the position and arrangement of the layers are calculated by determining a distance field. Each point of the model volume is assigned the shortest distance to the nearest starting surface within the model volume. Subsequently, several surfaces that build on one another are determined, wherein all points of the respective surfaces have the same distance to the nearest starting surface. Surfaces with the same distance from the nearest starting surface are referred to as isosurfaces. Each isosurface in turn has a constant distance to the previous isosurface and in the case of the first isosurface to the starting surface. From the isosurfaces the layers of the additive manufacturing process are formed in the context of the invention. Depending on a selected parameter, several isosurfaces can be combined into one layer.

The shape and distribution of the isosurfaces and layers adapt to the shape of the digital model, with the distance values of the isosurfaces defining a sequence, starting with the lowest distance values in ascending order and deriving therefrom the sequence of the layers for the additive construction.

For each discrete point of an isosurface or layer defined by a distance field, an orientation of the process head is determined. The orientation is hereby assigned by either calculating the surface normal of the layer or by calculating the gradient vectors of the distance field, which show the direction of the steepest increase of the distances for the discrete point.

The invention is based on the fundamental idea that the component geometry is divided in freely formed, three-dimensional isosurfaces or layers, so that need for implementing the sequential layer formation for modeling the component on support structures is eliminated. By deriving trajectories for 5 or multi-axle movement kinematics, a solid body can be created using additive manufacturing techniques with process heads that are suitable to be guided by such kinematics and allow a localized solidification. Path planning for implementation of the freely formed layers can be carried out with established methods for implementing conventional web patterns for external enveloping and internal filling structures.

The method according to the invention and the methodology for geometrical slicing as well as path planning makes it possible to construct a wide spectrum of components without support structures. This has the following main advantages:

Eliminating the need for support structures reduces production time for the production of additively manufactured components, since there is no need to even manufacture support structures. Moreover, the costly removal of the support structures is eliminated. Furthermore, use of resources for necessary supporting structures and production means for their production and removal is eliminated.

In addition, components with closed cavities can be produced from which, in other methods, depending on the process and the materials used, no support materials are removable.

The method according to the invention enables an automated calculation of a geometrical slicing, from which trajectories for guiding a process head can be generated when a printing surface non-planar. In addition to the component volume to be produced, component surfaces upon which applications shall be carried out can in principle be free-formed and assume a free position in space with the method according to the invention.

The method according to the invention for geometrical slicing and process path generation can be applied to various additive manufacturing methods based on element by element or layer by layer model design, such as fused layer manufacturing. The additive manufacturing processes combined with the process can be used, i.a., for the production of prototypes, series products and tools (rapid prototyping, rapid manufacturing and rapid tooling).

In particular, it is suitable for use in products which require a large amount of support structures in the conventional application. Moreover, it becomes possible to attach material volumes to existing objects by any orientation of the process head. Thus, the method according to the invention is also appropriate for repair of components to which appropriate repair volumes must be attached. These objects can also assume a variable position and freely formed.

According to a refinement of the invention, when there is a risk of collisions with the process head or movement kinematics, the direction of their orientation vectors can be modified for certain discrete points by determining vertices at which the previously determined orientation vectors of neighboring discrete points point towards each other. When the orientation vectors point to one another, this means that as the distance between the isosurfaces decreases, there will be insufficient space left for the process head. The directions of the orientation vectors of the discrete points are rotated relative to the vertices, with the proportion of the reorientation being selected as a function of the distance to the respective vertex. As the distance from the vertex increases, the proportion of reorientation decreases.

According to a refinement of the invention, to avoid a collision of a used process head for additive manufacturing with an already modeled component volume, the layer formation is to be adjusted by checking whether there are opposing orientation vectors, so that not only discrete points but entire layers run towards one another and would form an impact surface.

In the presence of an existing impact surface, the distance field is modified locally, regardless of the distance function. For this purpose, an auxiliary surface arranged orthogonally to the impact surface is determined and extends through an edge of an enveloping body surrounding the digital model of the impact surface. The normal of the auxiliary surface determines a buildup direction. A particular conical-shaped interfering contour volume of the process head is determined and placed in the region of the impact surface in the buildup direction and intersected with the model volume adjacent the impact surface. In the resulting intersection volume, referred to as replacement volume, only points with distance values less than or equal to the distance value of the impact surface are taken into account. In the replacement volume, the distance values, starting with the distance value of the impact surface, are increased sequentially in the buildup direction.

According to an advantageous refinement of the invention, applicability of the selection of an auxiliary surface and the buildup direction is checked in a separate collision test. When detecting a collision, another edge of the enveloping body is selected to determine the auxiliary surface and the buildup direction.

A further refinement of the method involves a checking as to whether volumes located in the buildup direction immediately adjacent to said replacement volume are arranged with smaller distance values than those in the impact surface. In this case, the interfering contour volume is placed in the region of these volumes in buildup direction and intersected with the model volume, again with smaller distance values than those in the impact surface. This is continued until no new intersection volumes are generated. By uniting these additional intersection volumes, the distance values are replaced starting with the distance value, increased by 1, of the highest distance value of the replacement volume and increased sequentially in the buildup direction.

According to an advantageous refinement of the invention, all distance values, outside the previously considered replacement volume and the further identified intersection volumes, are increased with a distance value greater than or equal to the distance value of the impact surface by a value greater by 1 than the number of isosurfaces that are changed in the replacement volume and in the further intersection volumes as a result of the change of the distance values.

The association of distance values results in a sequence of isosurfaces or layers that can be produced by the additive manufacturing process. This association of the layers or the adaptation of the isosurfaces is established automatically by the method according to the invention, so that, for example, overhangs across openings can be automatically closed in a volume.

In principle, the method is independent from the definition of the distance function. The distance function for determining a distance field can be calculated by means of the minimum distance between two points within the volume of the digital model. For discrete volume elements in the form of voxels, the distance 1 is assigned to the directly adjacent voxels or a subset of the directly adjacent voxels. The distances to other voxels are calculated from the minimum sum of the distances over respective adjacent voxels between the considered voxels. For example, the distance value 1 can be assigned to all adjacent voxels with a common face. As an alternative, the distance value 1 can be assigned to all neighboring voxels with a common vertex.

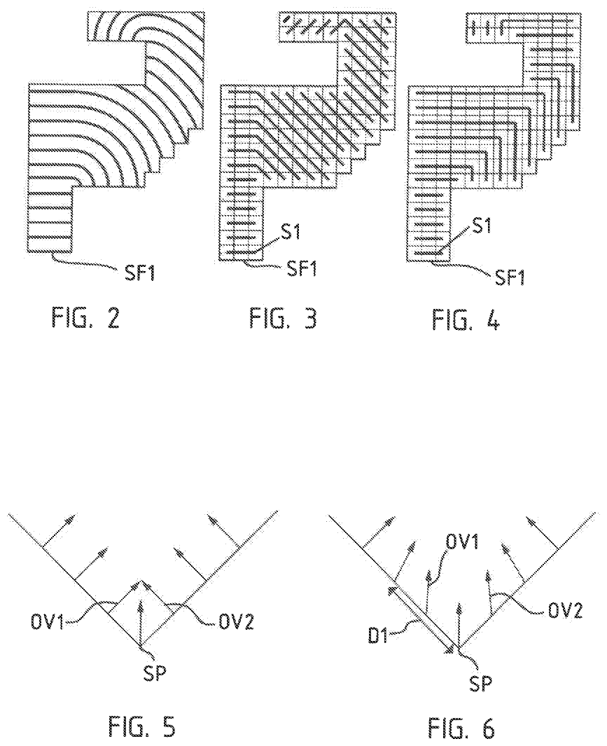

The method according to the invention will now be explained in greater detail using the example of a discretized volume and surface representation with reference to exemplary embodiments illustrated in the schematic drawings. In principle, however, this can also be applied to non-discretized parametric volumes and surfaces, as in FIG. 2.

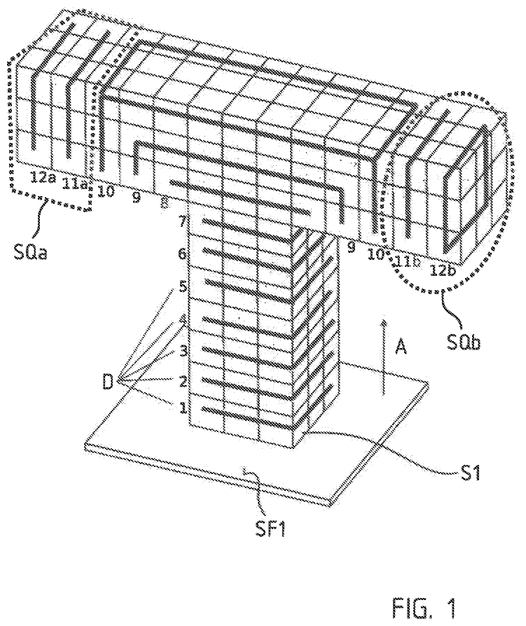

FIG. 1 shows the result of a geometrical slicing and definition of the layer sequence. The T-shaped solid body has a starting layer S1 with the distance value D=1 on a starting surface SF1. The subsequent layers are layers at same distance. They each have distance values D increased by 1, so that the layers build on each other. The layers following the starting layer S1 are designated hereinafter by their distance value D. The 8th layer causes as viewed in the buildup direction AR a lateral overhang compared to the 7th layer. The overhang by 1 voxel or volume element may still be possible without support from below, depending on the additive manufacturing process and the materials used. The next layer designated with the distance value 9 normally would already require a support structure necessary. However, the method according to the invention renders this moot, because the layer designated with 9 conforms to the shape of the layer designated with 8, i.e. adapts and can be produced without support as a result of the deflection in the corner. This is possible by reorienting the process head or by adapting the orientation vectors. An overhang is created, which does not require a support structure, because as a result of adapting the orientation vectors of the process head the layer actually to be printed is applied upon the respective preceding layer. The precursor layer thus forms exclusively the printing substrate, not a possible support structure. A support structure is not required despite the two-sided overhang.

FIGS. 2 to 4 show different possibilities of the layer buildup with different distance functions in a two-dimensional representation. FIG. 2 shows isosurfaces or layers of a continuous distance function as minimum distance within the component volume.

FIG. 3 shows a component volume discretized in voxels, with a distance function in which the distance value 1 is assigned to all adjacent voxels having a common surface (this corresponds in the two-dimensional representation to a common edge).

FIG. 4 shows a component volume discretized in voxels, with a distance function in which the distance value 1 is assigned to all adjacent voxels with a common vertex.

The number of isosurfaces used for model construction results from a parameter that indicates in how many steps the distance field is discretized. The number of isosurfaces from which the layers are generated is determined by a resolution parameter (quantization of the isosurfaces). The shape and distribution of the isosurfaces or layers are adapted to any component shapes. The sequence of the isosurfaces or layers for model construction through the additive manufacturing process automatically results from the distance values of the isosurfaces or layers, starting at the smallest distance value in ascending order.

FIGS. 5 and 6 show an exemplary representation for the modification of the orientation vectors of the process head. It can be seen in FIG. 5 that the orientation vectors OV1, OV2 of individual voxels point to one another. In the method according to the invention, vertices SP are determined in which this applies to adjacent discrete points. The vertices can be calculated via the scalar product of the two direction vectors. FIG. 6 shows that the directions of the orientation vectors OV1, OV2 of the discrete points are rotated relative to the vertices SP, wherein the proportion of the reorientation is selected as a function of the distance D1 to the respective vertex SP and the direction of the orientation can be defined by additional parameters, As the distance D1 increases, the proportion of reorientation decreases.

Depending on the component geometry, the process of geometrical slicing may encounter a division into layers which can no longer be realized due to collisions of a process head with previously produced layers. This can occur essentially with components having holes, cavities, or multiple starting surfaces.

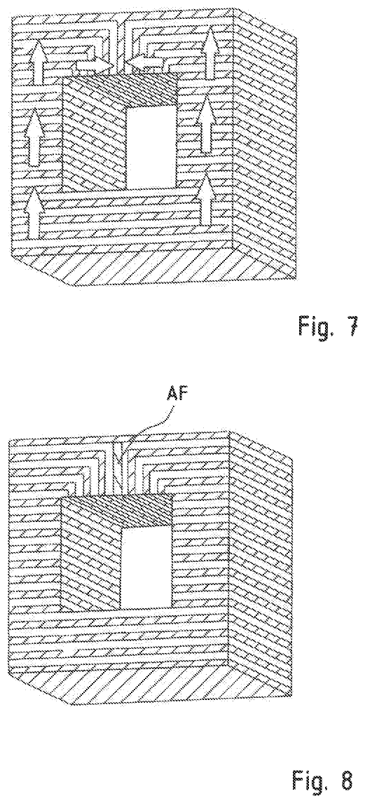

FIG. 7 shows an example of a cuboid with a through hole. For the layers above the passageway, i.e. above the hole, the normals of the layers point to each other, as symbolized by the arrows, in the direction of the opposite geometry. By aligning the process head orientation with the normals of the layers, a collision of the process head with previously modeled component layers results in the modeling process. To avoid such situations, the distance field must be adjusted.

All points whose neighboring points have opposite vectors of the vector field form the impact surface (AF) (FIG. 8). The upper central layer, which is vertical in the image plane, is such an impact surface as the result of two successive converging layers. Depending on the component geometry, the points in this layer form a surface or line.

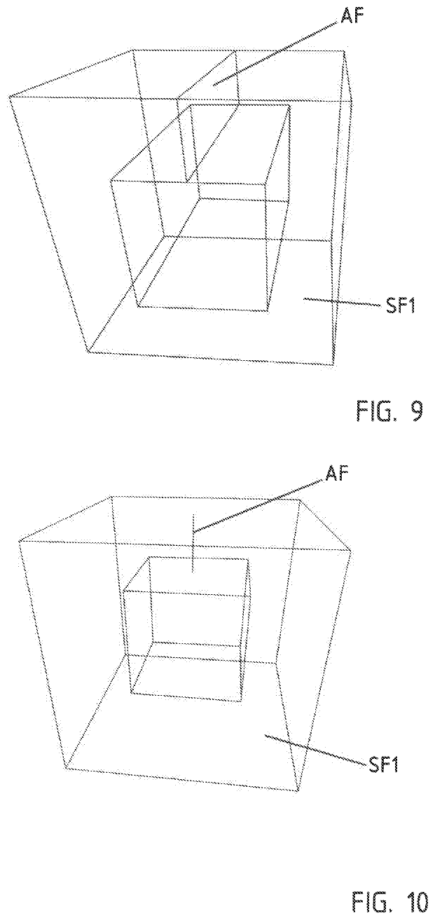

FIG. 9 shows the resulting surface for the example of the cuboid with through hole. FIG. 10 shows the resulting line for the specific case of the component with a symmetrically closed cavity. The case of the line can be considered as a special case of the surface in which the extent of the surface in one direction is 0 (or exactly 1 voxel). In the following, the procedure for the surface is described and this surface is designated as the impact surface AF.

First, a buildup direction A is determined for the impact surface AF, which is derived from an auxiliary surface HF which is orthogonal to the impact surface and extends through an edge of the convex envelope or the axis-aligned enveloping body H (axis-aligned bounding boxes) of the impact surface. The buildup direction A then corresponds to the normal of the auxiliary surface HF. Initially, any edge is selected, for example randomly or by means of a parameter that defines a preferred direction. Later, a collision check is implemented between the defined volume of the process head as an interfering contour volume with those layers that have a smaller or equal distance value D than the impact surface AF.

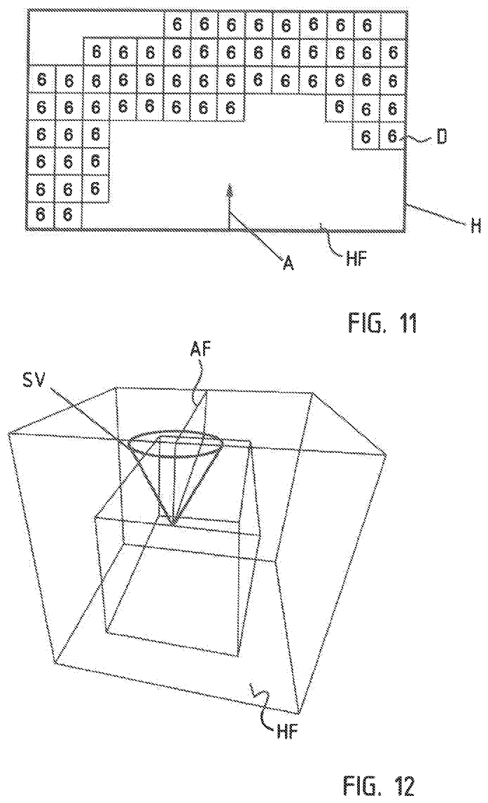

FIG. 11 shows an example for the two-dimensional voxel representation of the impact surface AF with an axis-aligned enveloping body and actually viewed buildup direction A. The buildup direction A within the enveloping body points upwards in the image plane.

In the next step, a volume is defined about the impact surface AF based on the definable interfering contour volume SV of the process head and the selected buildup direction A. The interfering contour volume SV is represented in this exemplary embodiment by a cone with an opening angle to be defined. The resulting volume is calculated by the union of these cones, aligned in the buildup direction A, placed at all points of the impact surface AF, intersected with the volume of all voxels with a distance smaller than the distance value of the impact surface AF.

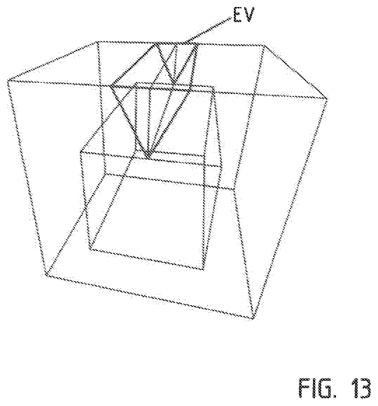

FIG. 12 shows the interfering contour volume SV of the process head as a cone, and FIG. 13 shows the resulting intersection volume of the cone, the so-called replacement volume EV, during a displacement along the impact surface AF.

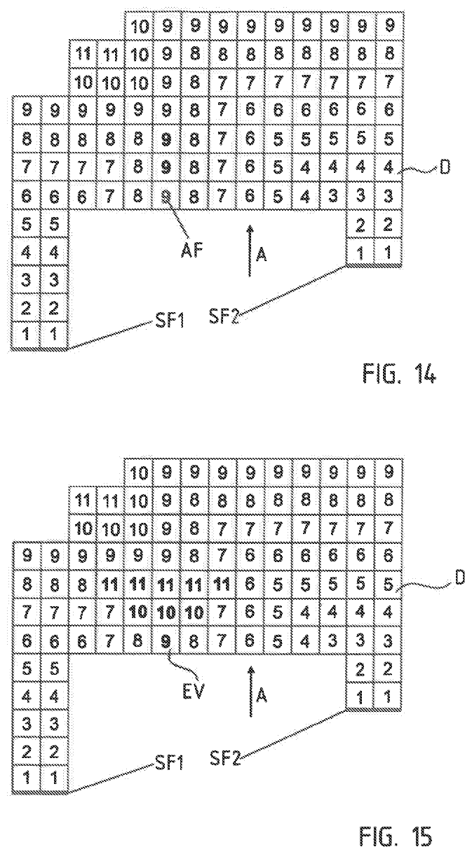

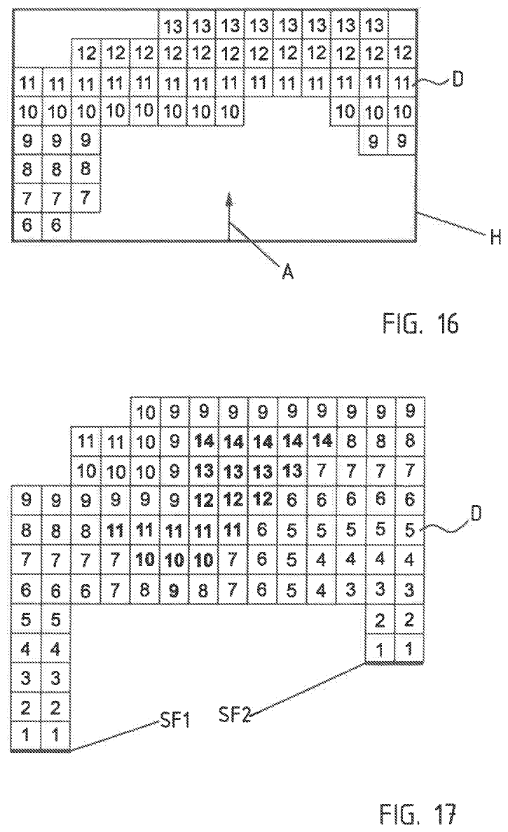

The distance values D within the replacement volume are now replaced in buildup direction A. Starting at the previous distance value of the impact surface AF, this distance value is incrementally increased (per voxel). This is comparable to a slicing in planar layers in buildup direction A. FIG. 14 shows the state before and FIG. 15 shows the state after, using an example in two-dimensional representation in viewing direction upon an edge of the impact surface AF. FIG. 14 shows the distance values D of the impact surface in bold type. FIG. 15 shows the matched distance values D of the voxels of the replacement volume EV in bold type. FIG. 16 shows the view from the point of view onto the impact surface for the example from FIG. 11.

In this exemplary embodiment, after this adaptation in buildup direction directly adjacent to the replacement volume, volumes with voxels are located having a smaller distance value D than the lowest distance value D of the impact surface (see FIG. 15).

The Interfering contour volume SV is placed in the region of these volumes in buildup direction A and intersected with the model volume, with smaller distance values than those in the impact surface AF, which is continued for as long as no new intersection volumes are produced. By uniting these further intersection volumes in buildup direction A, the distance values D, as shown in FIG. 17, are replaced, starting with the distance value D increased by 1, of the highest distance value D of the replacement volume EV, and increased sequentially.

In particular, a collision test can then be executed with the previously modeled layers of the component volume (layers which have a lower or equal distance value, such as the distance value of the viewed impact surface) with the process head (and, optionally, the kinematics leading it). The collision check is carried out for all points of the calculated replacement volume and the further calculated volumes in which distance values have been changed with selected sampling grid. When no collision is detected, the selected buildup direction A is maintained, otherwise another edge of the enveloping body and thus another buildup direction A is selected and checked for collisions with the described calculation steps.

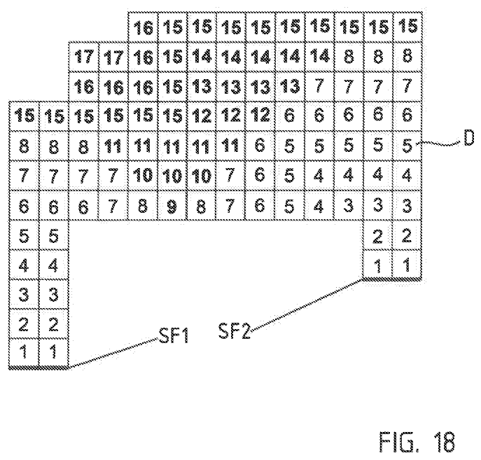

Finally, all distance values D of the voxels with hitherto unmodified distance values and a value greater than or equal to the distance value of the impact surface are increased by a value which is greater by 1 than the number of isosurfaces changed in the replacement volume and in the intersection volumes due to the change of the distance values (FIG. 18).

What is claimed is:

1.-12. (canceled)

13. A method for additive manufacture of a three-dimensional object, comprising:
providing a digital model of the three-dimensional object,
defining at least one starting surface on a surface of the digital model,
creating, by starting on the at least one starting surface, a layered subdivision of the model, wherein layers of the layered subdivision are built up sequentially additively to manufacture the three-dimensional object,
determining a position and an arrangement of the layers by calculating for at least one distance field that assigns each point of a volume of the digital model a shortest distance to a nearest starting surface according to a distance function to be defined,
defining at least one isosurface for the layers, wherein points of an isosurface have an identical distance with an identical distance value to the nearest starting surface, wherein for each discrete point of a layer defined by the isosurfaces of the distance field an orientation of a process head is determined by either calculating a surface normal of the layer or gradient vectors of the distance field, with the gradient vectors indicating for the discrete point a direction of steepest increase of the shortest distances,
adapting a shape and a distribution of the isosurfaces and layers to a shape of the digital model, with the distance values of the isosurfaces specifying a sequence of the layers for the additive build-up.

14. The method of claim 13, wherein the distance values of the isosurfaces define the sequence of the layers for the additive build-up, starting in ascending order from the smallest distance value.

15. The method of claim 14, wherein a number of isosurfaces used for the digital model is determined by a predetermined resolution parameter.

16. The method of claim 15, wherein the number of isosurfaces, from which the layers are generated, is determined by a further resolution parameter.

17. The method of claim 13, wherein the orientation of the process head is characterized by an orientation vector, the method further comprising
modifying for certain discrete points a direction of the corresponding orientation vectors by determining vertices where previously determined orientation vectors of adjacent discrete points point toward each other, and
rotating the direction of the previously determined orientation vectors relative to the vertices, wherein an amount of the rotation is selected as a function of a distance to the respective vertex, decreasing with increasing distance from the respective vertex.

18. The method of claim 15, wherein the orientation of the process head is characterized by an orientation vector, the method further comprising
for avoiding a collision of the process head, when used for additive manufacture, with an already modeled component volume, adjusting a build-up direction of the layer by checking whether orientation vectors pointing in opposite directions exist, which cause isosurfaces to converge towards each other and to form an impact surface.

19. The method of claim 18, further comprising, when an impact surface is present,
locally modifying the distance field independent of the distance function by determining an auxiliary surface arranged orthogonal to the impact surface and extending through an edge of a bounding volume surrounding the digital model of the impact surface, with a normal of the auxiliary surface determining the build-up direction,
determining an interfering contour volume of the process head and placing the interfering contour volume in a region of the impact surface in the build-up direction and generating an intersection volume by intersecting the interfering contour volume with the volume of the digital model adjacent to the impact surface, and taking into account for the intersection volume only points with distance values less than or equal to the distance values of the impact surface, and
generating a replacement volume in which, the distance values are sequentially incremented in the build-up direction, starting with the distance value of the impact surface, with a step width corresponding to the predetermined resolution parameter of the isosurfaces.

20. The method of claim 19, further comprising
checking whether volumes disposed directly adjacent to the replacement volume in the build-up direction have smaller distance values than those of the impact surface, in which case the interfering contour volume is placed in a region of these volumes in the build-up direction and intersected with these volumes,
continuing checking until no new intersection volumes are generated, and
when merging the intersection volumes in the build-up direction, replacing the distance values, starting with the distance value of the highest distance value of the replacement volume incremented by 1, and incrementing the distance values sequentially with an incremental step width corresponding to the resolution parameter of the isosurfaces.

21. The method of claim 19, further comprising
checking applicability of the determined auxiliary surface and the determined build-up direction by way of a collision check, and
selecting another edge for determining the auxiliary surface and the build-up direction when a collision is detected.

22. The method of claim 19, further comprising
increasing by a value all distance values, which are located outside of the replacement volume and outside of the intersection volume and have a distance value greater than or equal to the distance value of the impact surface, which value is greater by 1 than a number of isosurfaces that were changed in the replacement volume and in the intersection volume as a result of the change of the distance values.

23. The method of claim 13, wherein the digital model is a discretized voxel model or a parametric model which, if necessary, is partially discretized.

24. The method of claim 13, wherein the distance function for determining the distance field is calculated from a minimum distance between two points within the volume of the digital model, or wherein with discrete volume elements in form of voxels, a distance of 1 is assigned to a distance between a voxel and directly adjacent voxels or to a subset of directly adjacent voxels, and distances between a voxel and other non-adjacent voxels are calculated from a smallest sum of all distances between adjacent voxels disposed between the voxel and the non-adjacent voxels.
